(19) United States
(12) Patent Application Publication
(10) Pub. No.: US 2025/0133317 A1
(43) Pub. Date: Apr. 24, 2025

(54) Acoustic Driver with Liquid Silicone Rubber (LSR) Surround

(71) Applicant: Bose Corporation, Framingham, MA (US)

(72) Inventors: Alexander Irwin, Belmont, MA (US); Marek Kawka, Bolton, MA (US)

(21) Appl. No.: 18/383,117

(22) Filed: Oct. 24, 2023

(51) Int. Cl. H04R 1/02; H04R 9/08; H04R 31/00

(52) U.S. Cl. CPC H04R 1/026; H04R 9/08; H04R 31/006; H04R 2201/029; H04R 2400/11

(57) ABSTRACT

Various implementations include an acoustic driver having: a piston with a plurality of protrusions extending around a periphery thereof; and a liquid silicone rubber (LSR) surround, where the LSR surround extends around the plurality of protrusions.

### TECHNICAL FIELD

This disclosure generally relates to loudspeakers. More particularly, the disclosure relates to transducers (e.g., micro transducers) with a structurally reinforced piston.

### BACKGROUND

Reliably manufacturing small-scale (e.g., micro) transducers presents a number of challenges. For example, micro transducers can have thin moving components such as the piston and surround, which can be difficult to form in high-yielding processes without introducing manufacturing defects.

### SUMMARY

All examples and features mentioned below can be combined in any technically possible way.

Various implementations include an acoustic driver with a piston that has protrusions, and an integrated surround for enhanced structural integrity.

In some particular aspects, an acoustic driver includes: a piston having a plurality of protrusions extending around a periphery thereof; and a liquid silicone rubber (LSR) surround, where the LSR surround extends around the plurality of protrusions.

In other particular aspects, an acoustic driver includes: a piston having a plurality of protrusions extending around a periphery thereof; and a surround formed around the piston, where the surround extends around the plurality of protrusions.

In additional particular aspects, a method of forming an acoustic driver includes: using a first mold portion and a second mold portion: applying pressure to a piston material, and molding liquid silicone rubber (LSR) around the first mold portion and the second mold portion to form a driver piston.

Implementations may include one of the following features, or any combination thereof.

In some cases, adjacent protrusions in the plurality of protrusions define channels through which LSR flows during formation of the LSR surround.

In certain aspects, portions of the LSR surround extend between adjacent protrusions in the plurality of protrusions.

In some cases, the plurality of protrusions structurally reinforce the piston.

In some cases, the plurality of protrusions enhance a surface area for sealing the LSR during molding of the LSR surround.

In some cases, the plurality of protrusions includes at least three protrusions.

In some cases, the plurality of protrusions are positioned around the periphery of the piston and are approximately equidistant from a center of the acoustic driver.

In some cases, each of the plurality of protrusions extends from a first side of the piston and is approximately aligned with a ring on a second, opposing side of the piston.

In some cases, the driver further includes a voice coil.

In some cases, relative to an axis of movement of the piston (A), the ring is radially inboard of the voice coil.

In some cases, an outer diameter (OD) of the driver is less than approximately 10 millimeters (mm), and in additional cases, less than approximately 8 mm.

In some cases, a position of the bobbin relative to the ring enables desirable true-position of the bobbin to the motor components, reducing rocking of the driver during operation, which can improve acoustic output of the driver without causing buzzing.

In some cases, the piston has a diameter of approximately 2 mm to approximately 8 mm, and the LSR surround has a thickness of approximately 10 microns to approximately 50 microns.

In some cases, the piston includes at least one of a thermoplastic or a metal.

In some cases, a method includes forming the acoustic driver.

In some cases, the piston material includes a plurality of protrusions extending around a periphery thereof, and the LSR flows around the plurality of protrusions during the molding of the LSR, where adjacent protrusions in the plurality of protrusions define channels through which LSR flows during molding of the LSR.

In some cases, the plurality of protrusions structurally reinforce the driver piston.

In some cases, the plurality of protrusions enhance a surface area for sealing the LSR during molding of the LSR.

Two or more features described in this disclosure, including those described in this summary section, may be combined to form implementations not specifically described herein.

The details of one or more implementations are set forth in the accompanying drawings and the description below. Other features, objects and benefits will be apparent from the description and drawings, and from the claims.

### BRIEF DESCRIPTION OF THE DRAWINGS

FIG. 1 is a schematic depiction of an example micro driver (or, micro transducer) according to various implementations.

FIG. 2 is a schematic cut-away perspective view of a micro driver according to various implementations.

FIG. 3 is a cross-sectional view of a portion of the micro driver in FIG. 2 according to various further implementations.

FIG. 4 is a cross-sectional view of a portion of the micro driver in FIGS. 2 and 3, further depicting a bobbin, according to various further implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

This disclosure is based, at least in part, on the realization that a small-scale (e.g., micro) driver (or, transducer) can be manufactured with a surround that is integrated with a piston. In certain examples, the piston includes a plurality of protrusions extending around a periphery, and a surround (e.g., LSR surround) extends around the plurality of protrusions.

Commonly labeled components in the FIGURES are considered to be substantially equivalent components for the purposes of illustration, and redundant discussion of those components is omitted for clarity. Numerical ranges and values described according to various implementations are merely examples of such ranges and values, and are not intended to be limiting of those implementations. In some cases, the term “approximately” is used to modify values, and in these cases, can refer to that value+/−a margin of error, such as a measurement error, which may range from 1 percent up to 5 percent in terms of dimensional tolerance in some cases.

In contrast to conventional micro drivers (or, micro transducers), the micro drivers disclosed according to various implementations include a surround formed integrally around protrusions in a piston. At least one benefit of such drivers is the ability to provide desirable acoustic displacement with thin materials at small scale, along with the ability to manufacture such structures reliably.

This disclosure is related to U.S. patent application Ser. No. 17/636,097 (“Highly Compliant Electro-Acoustic Miniature Transducer”, filed Aug. 21, 2020), U.S. patent application Ser. No. 15/182,014 (“Assembly Aid for Miniature Transducer”, filed on Jun. 14, 2016, now U.S. Pat. No. 9,986,355), and U.S. patent application Ser. No. 15/182,055 (“Electro-Acoustic Driver Having Compliant Diaphragm with Stiffening Element”, filed on Jun. 14, 2016, now U.S. Pat. No. 9,942,662), each of which is incorporated by reference herein for all purposes.

Acoustic transducers structurally similar to those described in the above referenced patent applications and/or the disclosure herein, and/or assembled in accord with methods similar to those described in the above referenced patent applications or those described herein, may meet dimensional criteria and material composition and/or characteristic criteria in accord with those described herein.

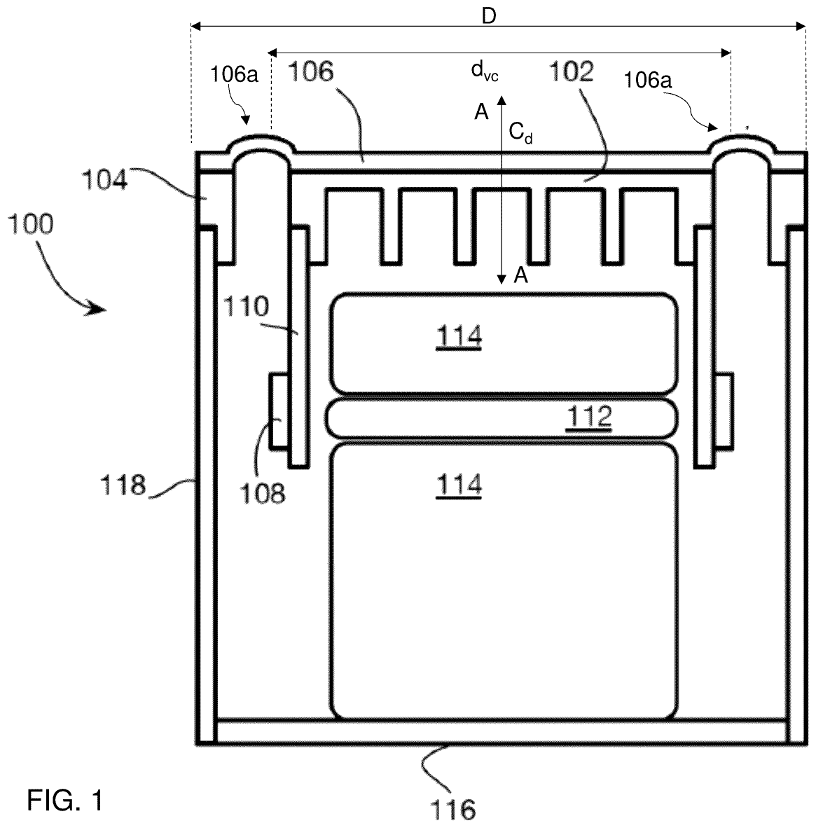

FIG. 1 illustrates an example conventional acoustic driver (or, transducer) 100 that includes a piston (also referred to as a cone, or diaphragm) 102 suspended from a support structure 104 by a suspension 106. In various implementations, such as where the driver 100 is formed in an approximately circular cross-sectional shape, the support structure 104 includes a support ring. In various examples, the suspension 106 includes a layer of compliant material extending over the entire surface of the piston 102, and may form a portion of the cone (e.g., the primary radiating surface area), though in some examples the compliant material of the suspension 106 may not extend over the entire surface of piston 102. In such cases, this suspension 106 may be referred to as a “surround,” in that it surrounds the piston 102 and suspends the piston 102 from the support structure 104. In certain cases, a portion of suspension 106a has a non-planar shape in a resting position. In this example, the suspension 106a has a rounded or “half-roll” shape, e.g., half-rolled shape in the resting position. In various examples having a half-roll suspension 106a, a material such as LSR (silicone) having a thickness of about 10 to 50 microns may be suitable. The remaining parts of the driver 100 include a voice coil 108 wound around a bobbin 110, surrounding a center pole assembly that includes a coin 112 and magnet(s) 114.

The coin 112 and magnet(s) 114 may be connected to the support ring by a back plate 116 and housing 118, which, like the coin 112, may be formed of ferromagnetic material, such as steel. Electrical current flowing through the voice coil 108 within the field produced by the magnet(s) 114 and shaped by the ferromagnetic parts produces a force on the voice coil 108 in the axial direction. This is transferred to the piston (or, cone, or, diaphragm) 102 by the bobbin 110, resulting in motion of the piston 102, and the production of sound. The same effects can be used in reverse to produce current from sound, i.e., using the driver as a microphone or other type of pressure sensor. In other examples, the voice coil 108 may be stationary (e.g., coupled to the back plate 116 and the housing 118) and the magnet(s) 114 may move (e.g., coupled to the piston 102, such as via the bobbin 110).

The driver 100 has an overall outer diameter, D, which may be the outer diameter of the support structure (e.g., outer ring) 104, such that the outer diameter of the suspension (or, surround) 106 may be somewhat smaller in some examples. The piston 102 has a piston (or, diaphragm) diameter smaller than the outer diameter, D. In operation, a portion of the suspension 106 may contribute to a radiating surface of the piston 102. Accordingly, the transducer 100 has an effective piston diameter, being of a value between the piston diameter and the outer diameter of the suspension 106. In some examples, the effective radiating surface may include the piston 102 and about half of the radial width of the suspension 106. An effective radiating area, of the transducer 100 may therefore be more than the physical area of the piston 102. Aspects of these dimensions are further described, for example, in U.S. patent application Ser. No. 17/636,097 (previously incorporated by reference herein).

As variously described, transducers in accord with those herein have outer diameters of approximately 8.0 mm or less, and in many examples have outer diameters of approximately 6.0 mm or less. While the above descriptions refer to various diameters, many examples may not be circular. For example, the structure overall may be oblong, oval, or have a racetrack shape or other physical structure. In such examples, the overall largest linear dimension in the plane of the support structure (e.g., a plane that is perpendicular to the axis of motion of the piston) may be 8.0 mm or less, and in some particular cases, 6.0 mm or less. In some examples, the driver 100 can have an effective radiating surface area of approximately 80 mm² or less, in some cases approximately 60 mm² or less, and in further cases approximately 40 mm² or less.

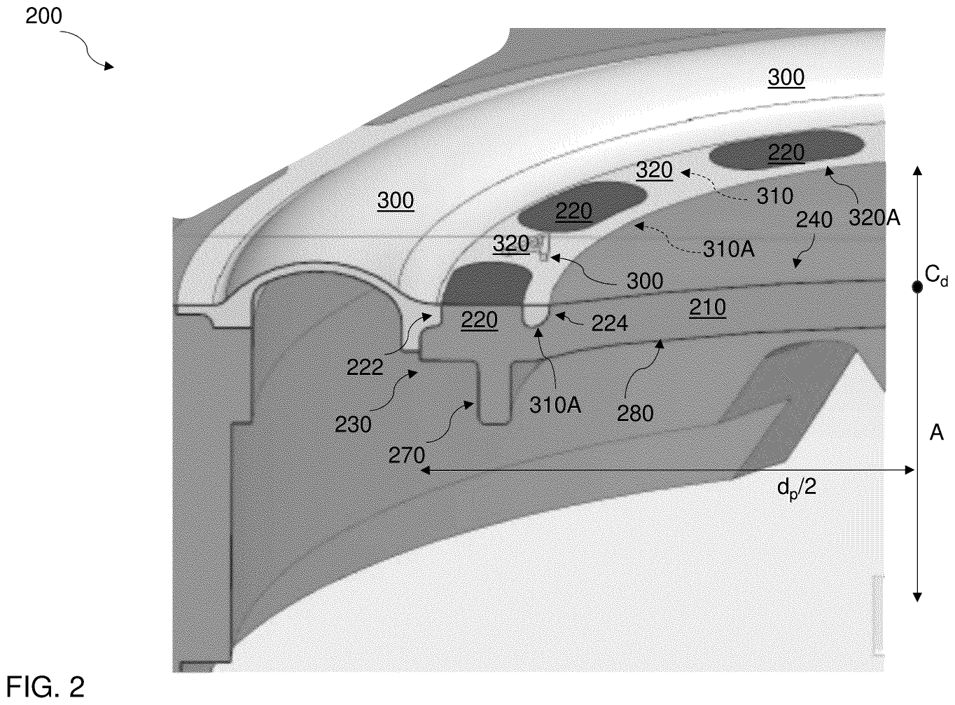

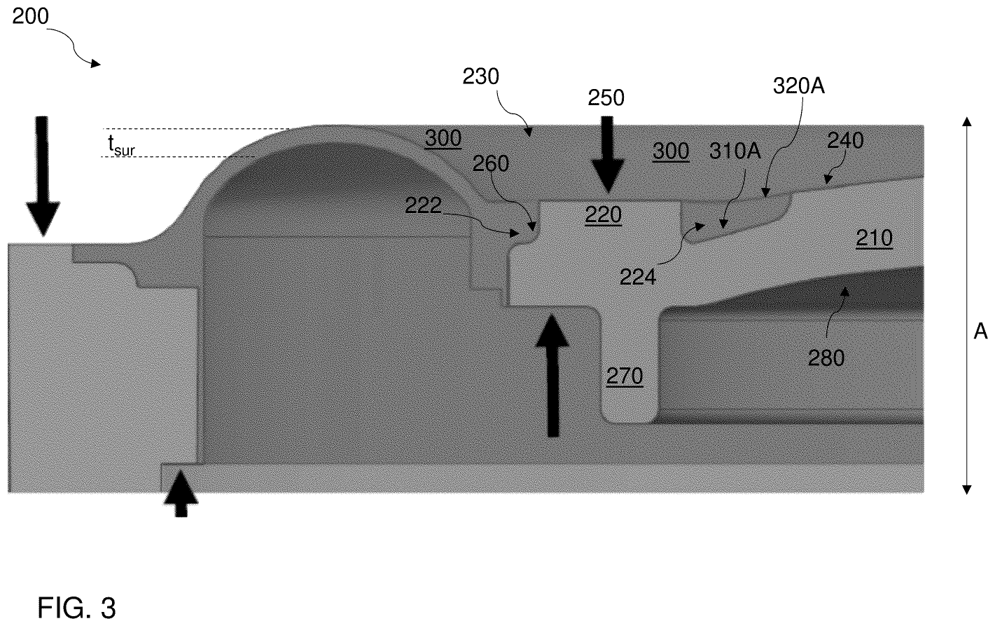

As stated above, it can be challenging to effectively (e.g., reliably) manufacture ever smaller drivers with a surround that provides sufficient compliance while maintaining structural integrity. FIGS. 2-4 illustrate portions of a driver 200 according to various implementations that can be reliably manufactured while providing desirable compliance and durability. FIG. 2 shows a first cut-away perspective, and FIG. 3 shows a cross-section of a portion of the driver 200, according to various implementations.

Referring to FIGS. 2-4, the driver 200 can include a piston 210. In various implementations, piston 210 includes a thermoplastic and/or a metal. In certain cases, piston 210 has a plurality of protrusions 220 extending around its periphery 230. In certain cases, the protrusions 220 are positioned circumferentially about the periphery 230 of the piston. In certain cases, the protrusions 220 are approximately equidistant from a center (Ca) of the driver 200. According to various implementations, each protrusion 220 extends from a first (e.g., outer) side 240 of the piston 210. As described with reference to driver 100, it is understood that the piston 210 can have an approximately circular shape, but in certain cases, can be non-circular (e.g., oblong), and in such cases, protrusions 220 can be positioned about the periphery of that non-circular shape.

Protrusions 220 can take any of a number of shapes, including circular, squared, oblong, etc. Further, when viewed cross-sectionally (e.g., as in FIG. 3), protrusions 220 can have a gradient or slope, such that the radial thickness of the protrusion 220 is less at an upper surface 250 than at the base 260 of the protrusion 220. In some cases, at least three protrusions 220 are positioned around the piston 210. In more particular cases, five, six, seven, eight, nine, ten, or more protrusions 220 are positioned around the piston 210. In various implementations, the protrusions 220 structurally reinforce the piston 210. In certain cases, protrusions 220 are at least partially defined by recesses 222, 224 on either side (e.g., radially inboard or outboard of the protrusion 220).

As shown in FIGS. 2-4, the piston 210 can further include a ring (or, inner ring) 270 on a second side 280 of the piston 210. The second side 280 opposes the first side 240, e.g., being closer to the voice coil 114 than the first side 240. In various implementations, protrusions 220 are approximately radially aligned with the ring 270 (e.g., equally spaced from the primary axis (A) that extends through the driver center (Ca)). In certain implementations, protrusions 220 are radially inboard (e.g., relative to axis (A)) of the ring 270. Further, in some examples, protrusions 220 can extend from the first side 240 by approximately 30 microns to approximately 70 microns, while the ring 270 can extend from the second side 280 by approximately 140 microns to approximately 190 microns. In more particular examples, protrusions 220 extend from first side 240 by approximately 40-60 microns, and in more particular cases, approximately 50 microns. In further examples, ring 270 extends from second side 280 by approximately 150 to 180 microns, and in more particular cases, approximately 165 microns.

With continuing reference to FIGS. 2-4, the driver 200 can also include a surround 300, e.g., connecting the piston 210 to a support structure 104. In a particular example, the surround 300 is formed substantially of an elastomer such as liquid silicone rubber (LSR). In certain cases, the surround 300 is formed entirely of LSR. In various implementations, the surround 300 extends around the plurality of protrusions 220 in the piston 210. For example, the surround 300 can be formed by flowing LSR over portions of the piston 210, such that adjacent protrusions 220 define channels 310 through which the LSR flows. In particular cases, additional channels 310A extend around the protrusion 220, e.g., such that the LSR surrounds protrusions 220, connecting LSR extending through neighboring channels 310. In certain cases, after formation of the surround 300 (e.g., hardening of the LSR), portions 320 of the surround 300 extend between adjacent protrusions 220. In particular cases, additional portions 320A of the surround 300 extend around protrusion 220, e.g., are located radially inboard of the protrusions 220 (relative to Ca). In this sense, the protrusions 220 enhance a surface area for sealing the LSR during molding of the LSR surround 300 over the piston 210.

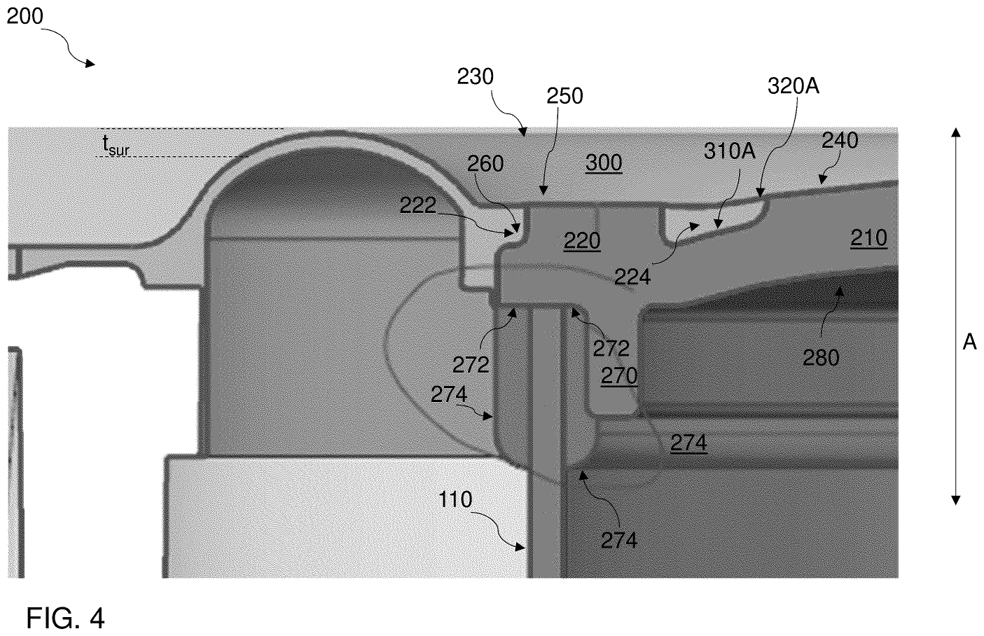

In various implementations, similar to driver 100, driver 200 includes a voice coil 108, and can include a similar bobbin 110 illustrated in the cross-sectional view of a portion of driver 200 in FIG. 4. In certain cases, the ring 270 is radially inboard of the bobbin 110 (e.g., relative to axis (A)). In particular implementations, the piston 210 has a diameter (dp) of approximately 2 mm to approximately 10 mm, and in particular cases, dp is approximately 6.0 mm or less, 5.0 mm or less, or 4.0 mm or less. In particular implementations, the piston 210 has a diameter (dₚ) of approximately 2 mm-3.5 mm, and in more particular cases, approximately 2.5 mm-3 mm. FIG. 2 shows the radius, or dₚ/2 of the piston 210. In some cases, the LSR surround 300 has a thickness (tₛᵤᵣ) of approximately 10 microns to approximately 50 microns, as illustrated in FIG. 3 and FIG. 4.

In particular implementations, a position of the bobbin 110 relative to the ring 270 mitigates rocking of the acoustic driver 200 relative to a reference acoustic driver, e.g., driver 100 in FIG. 1. Further, as illustrated in FIG. 4, the ring 270 enables enhanced bonding surface area between the bobbin 110 and the piston 210. In particular implementations, the ring 270, and corresponding overhang 272, enables bonding material 274 to be applied both radially inboard of the bobbin 110 and radially outboard of the bobbin 110 to bond the bobbin 110 to the piston 210. These implementations enable beneficial bonding of the bobbin 110 to the piston 210 with thin materials, which can enable beneficial acoustic output parameters.

Further, the various implementations of driver 200 described herein can provide beneficial radiating area for acoustic output, particularly when compared with conventional drivers. For example, the driver 200 enables a wider (greater) outer dimension of the bobbin and required area for adhesive attach 110 when compared with conventional drivers, which can accommodate a larger center pole assembly (magnets and coin). This enables greater radiating area for the piston 210 and surround 300, and also provides sufficient spacing between the bobbin 110 and the center pole assembly to mitigate rocking (e.g., at lower frequencies).

While various implementations describe the surround 300 as including or being formed primarily of LSR, in other implementations, the material of the surround 300 may be a distinct elastomer, or in other cases, a polyurethane, which may be an elastomeric polyurethane. Suitable polyurethanes may include thermoset polyurethanes or thermoplastic polyurethanes (TPUs). Other materials may also be suitable. The surround 300 may be formed by various methods, such as deposition, extrusion, thermo-forming, injection molding, or others.

In a particular example, the driver 200 is formed using a mold, e.g., to mold the surround 300 over the piston material. In certain examples, a method uses a first mold portion and a second mold portion to form the surround 300 over the driver 200. In this example, the method includes: i) applying pressure to a piston material (e.g., piston 210) using the first mold portion and the second mold portion, and molding LSR around the first mold portion and the second mold portion to form the driver 200. As noted herein, protrusions 220 enhance a surface area for sealing the LSR during molding of the LSR surround 300 over the piston 210. In certain cases, the LSR flows into channels 310, 310A around the protrusions 220, enhancing surface bonding with the piston 210.

Other example drivers (or, transducers) in accord with those described are not round, but may be oblong, oval, racetrack, etc., for which a diameter ratio may not be meaningful. In such examples, the piston surface area may be greater than 49% of the overall cross-sectional area of the driver 200 (e.g., as measured in the plane of the support structure, which is substantially perpendicular to the motion axis A of the cone). In some examples, the piston surface area may be greater than 53% of the overall cross-sectional area, and in certain examples, the piston surface area may be greater than 57% of the overall cross-sectional area. In even further implementations, the piston surface area is at least 49% of an overall cross-sectional area of the acoustic driver 200.

As noted herein, the transducers (drivers) disclosed according to various implementations can enhance performance relative to conventional micro drivers. These drivers include a surround or suspension with enhanced bonding to the piston. At least one benefit of such drivers is the ability to provide desirable acoustic displacement with thin materials at small scale. Further, such drivers can be manufactured with minimal (i.e., acceptable) manufacturing variation, thereby increasing longevity when compared with conventional micro drivers.

One or more components in the driver(s) can be formed of any conventional loudspeaker material, e.g., a heavy plastic, metal (e.g., aluminum, or alloys such as alloys of aluminum), composite material, etc. It is understood that the relative proportions, sizes and shapes of the transducer(s) and components and features thereof as shown in the FIGURES included herein can be merely illustrative of such physical attributes of these components. That is, these proportions, shapes and sizes can be modified according to various implementations to fit a variety of products. For example, while a substantially circular-shaped driver may be shown according to particular implementations, it is understood that the driver could also take on other three-dimensional shapes in order to provide acoustic functions described herein.

| In various implementations, components described as being “coupled” to one another can be joined along one or more interfaces. In some implementations, these interfaces can include junctions between distinct components, and in other cases, these interfaces can include a solidly and/or integrally formed interconnection. That is, in some cases, components that are “coupled” to one another can be simultaneously formed to define a single continuous member. However, in other implementations, these coupled components can be formed as separate members and be subsequently joined through known processes (e.g., soldering, fastening, ultrasonic welding, bonding). In various implementations, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

A number of implementations have been described. Nevertheless, it will be understood that additional modifications may be made without departing from the scope of the inventive concepts described herein, and, accordingly, other implementations are within the scope of the following claims.

We claim:

1. An acoustic driver comprising:
a piston having a plurality of protrusions extending around a periphery thereof; and
a liquid silicone rubber (LSR) surround,
wherein the LSR surround extends around the plurality of protrusions.

2. The acoustic driver of claim 1, wherein adjacent protrusions in the plurality of protrusions define channels through which LSR flows during formation of the LSR surround.

3. The acoustic driver of claim 1, wherein portions of the LSR surround extend between adjacent protrusions in the plurality of protrusions.

4. The acoustic driver of claim 1, wherein the plurality of protrusions structurally reinforce the piston.

5. The acoustic driver of claim 1, wherein the plurality of protrusions enhance a surface area for sealing the LSR during molding of the LSR surround.

6. The acoustic driver of claim 1, wherein the plurality of protrusions includes at least three protrusions.

7. The acoustic driver of claim 1, wherein the plurality of protrusions are positioned around the periphery of the piston and are approximately equidistant from a center of the acoustic driver.

8. The acoustic driver of claim 1, wherein each of the plurality of protrusions extends from a first side of the piston and is approximately aligned with a ring on a second, opposing side of the piston.

9. The acoustic driver of claim 8, further comprising a voice coil and a bobbin coupled with the voice coil, wherein the bobbin is coupled with the piston.

10. The acoustic driver of claim 9, wherein relative to an axis of movement of the piston (A), the ring is radially inboard of the bobbin.

11. The acoustic driver of claim 9, wherein an outer diameter (OD) of the acoustic driver is approximately 10 millimeters (mm) or less.

12. The acoustic driver of claim 9, wherein a position of the bobbin relative to the ring mitigates rocking relative to a reference acoustic driver.

13. The acoustic driver of claim 9, wherein the piston has a diameter of approximately 2 millimeters (mm) to approximately 8 mm and the LSR surround has a thickness of approximately 10 microns to approximately 50 microns.

14. The acoustic driver of claim 1, wherein the piston includes at least one of a thermoplastic or a metal.

15. A method of forming the acoustic driver of claim 1.

16. A method of forming an acoustic driver, the method comprising:
using a first mold portion and a second mold portion:
applying pressure to a piston material, and
molding liquid silicone rubber (LSR) around the first mold portion and the second mold portion to form the acoustic driver.

17. The method of claim 16, wherein the piston material includes at least one of a thermoplastic or a metal.

18. The method of claim 16, wherein the piston material includes a plurality of protrusions extending around a periphery thereof, and wherein the LSR flows around the plurality of protrusions during the molding of the LSR, wherein adjacent protrusions in the plurality of protrusions define channels through which LSR flows during molding of the LSR.

19. The method driver of claim 18, wherein the plurality of protrusions structurally reinforce the driver piston.

20. The acoustic driver of claim 18, wherein the plurality of protrusions enhance a surface area for sealing the LSR during molding of the LSR.
